(19) United States
(12) Patent Application Publication
(10) Pub. No.: US 2013/0046486 A1
(43) Pub. Date: Feb. 21, 2013

(54) SPEED RATE ERROR REDUCTION IN A PULSE DISPLACEMENT CONVERTER SYSTEM

(71) Applicant: John D. Pennell, Enfield, CT (US)

(72) Inventor: John D. Pennell, Enfield, CT (US)

(73) Assignee: HAMILTON SUNDSTRAND CORPORATION, Windsor Locks, CT (US)

(21) Appl. No.: 13/212,470

(22) Filed: Aug. 18, 2011

(51) Int. Cl. G01L 5/00; G06F 19/00

(52) U.S. Cl. 702/43

(57) ABSTRACT

A method for determining a duty cycle in a pulse displacement system, includes generating an analog waveform indicative of an angular displacement of a reference wheel from a wheel; generating a pulse waveform of the analog waveform; generating a duty cycle waveform responsive to the generating of the pulse waveform; accumulating a first count of high states of the duty cycle waveform; accumulating a second count of low states of the duty cycle waveform; determining a first average for the first count and a second average for the second count; and calculating a duty cycle of the pulse waveform as a function of the first average and the second average. Also, the first count includes an additional high state over the low state.

### FIELD OF INVENTION

This invention relates generally to control systems for helicopters and, more particularly, to a method and system for measuring rotor torque using pulse displacement including a duty-cycle to digital converter (DCTDC).

### DESCRIPTION OF RELATED ART

Proper power application to a helicopter rotor required for proper load and flight control. To improve engine power management and aid in rotor torque control, modern helicopter engine control systems utilize a torque measurement system to predict engine power requirements during load changes, such as, for example, during ascent or descent. A torque sensing system is generally found in the power output portion of a turbine engine used to drive the rotors of the helicopter and the torque sensing system, in conjunction with engine control hardware and software, converts the sensing system to a value that represents the torque applied to the rotor drive shaft of the helicopter.

The torque sensing system utilizes a pulse displacement measurement system comprised of a reference shaft-toothed wheel and a displacement toothed wheel connected to the power output portion of the turbine engine. Rotor shaft torque causes the toothed wheels to be displaced relative to each other and this displacement is sensed for each tooth on the wheels by the magnetic pick-up sensor. The electrical pulse output from the pick-up is interfaced to the engine control which includes an electronic pulse displacement measurement circuit, which employs the DCTDC circuit and software executed by a computer system to convert pulse displacement to a torque value. The torque value is used by an engine control to regulate engine power application to the rotor.

In existing systems using a DCTDC, the time intervals between sequential pick-up pulses are accumulated by two digital counters. Under a constant torque and a constant speed condition of the drive shaft, the calculated duty cycle is constant. However, for an accelerating or decelerating drive shaft, the proportional number of pulse clock counts accumulated for the DCTDC for sequential pulses will differ causing a duty cycle error. As a result, an erroneous torque value will be calculated and subsequently, an incorrect engine power command will be output to the engine by the engine control. For optimum rotor control, the error of the engine power command needs to be minimized due to drive shaft changes.

### BRIEF SUMMARY

According to one aspect of the invention, a pulse displacement system, includes a sensor for generating an analog waveform indicative of an angular displacement of a reference wheel from a displacement wheel; a comparator for generating a pulse waveform of the analog waveform; a flip flop for generating a duty cycle waveform responsive to the generating of the pulse waveform; a first counter for accumulating a first count of high states of the duty cycle waveform; a second counter for accumulating a second count of low states of the duty cycle waveform; and a processor for determining a first average for the first count and determining a second average for the second count. The first count includes an additional high state over the low state, while the processor calculates a duty cycle of the pulse waveform as a function of the first average and the second average.

According to another aspect of the invention, a method for determining a duty cycle in a pulse displacement system, includes generating, via a sensor, an analog waveform indicative of an angular displacement of a reference wheel from a wheel; generating, via a comparator, a pulse waveform of the analog waveform; generating, via a flip flop, a duty cycle waveform responsive to the generating of the pulse waveform; accumulating, via a first counter, a first count of high states of the duty cycle waveform; accumulating, via a second counter, a second count of low states of the duty cycle waveform; determining, via a processor, a first average for the first count and a second average for the second count; and calculating, via the processor, a duty cycle of the pulse waveform as a function of the first average and the second average, where the first count includes an additional high state of the duty cycle waveform.

Other aspects, features, and techniques of the invention will become more apparent from the following description taken in conjunction with the drawings.

### BRIEF DESCRIPTION OF THE SEVERAL VIEWS OF THE DRAWINGS

Referring now to the drawings wherein like elements are numbered alike in the FIGURES:

FIG. 1 illustrates a schematic block diagram of the pulse displacement converter system according to an embodiment of the invention;

FIG. 2 illustrates a functional block diagram of the logic control circuit of FIG. 1 used for processing the electrical pulse outputs from a signal source according to an embodiment of the invention;

FIG. 3 illustrates waveforms useful in explaining the operation of the logic control circuit of FIG. 2 according to an embodiment of the invention; and

FIG. 4 illustrates a functional block diagram of an algorithm that calculates the average pulse interval counts for each pulse that is used for calculating a duty cycle and torque value according to an embodiment of the invention.

### DETAILED DESCRIPTION

Embodiments of a shaft speed rate error in a drive shaft torque acquisition system utilizing a pulse displacement torque converter method is compensated in a duty cycle to digital converter (DCTDC). The DCTDC utilizes one additional count interval on one of two pulse interval counters within the DCTDC. Also, the counter total count values obtained by the DCTDC are divided by the number of pulse intervals, which provides average pulse interval count values. The averaged pulse interval counts values represent concurrent pulse durations at the center of the acquisition period. Conversion of the two averaged count values to a duty cycle is more accurate under shaft speed acceleration and deceleration and the similarly improved torque value calculated from the duty cycle which is used by the engine control system to regulate engine power application and results in optimum drive shaft control.

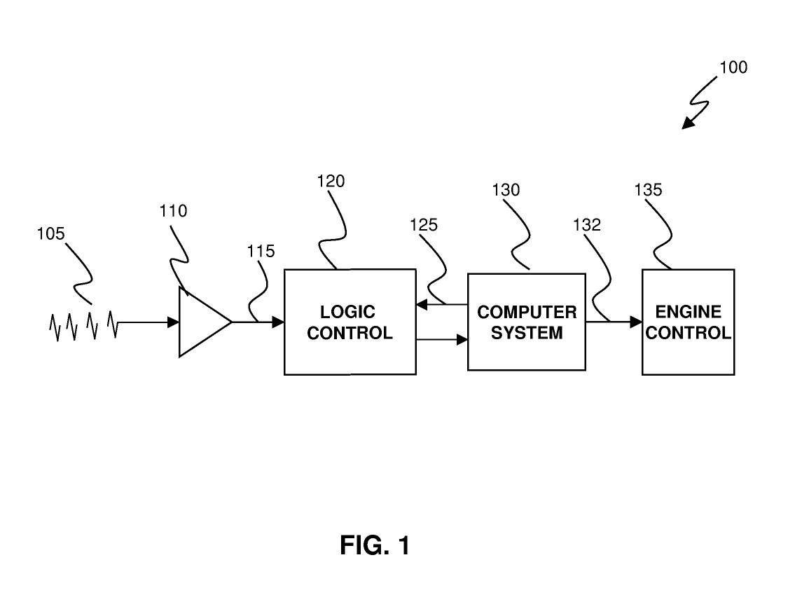

Referring now to FIG. 1, an example of a pulse displacement to torque system 100 (also referred to as “pulse displacement system 100”) for regulating the power to a drive shaft of a rotor is illustrated. Particularly, the pulse displacement system 100 includes a logic control circuit 120 communicating with a computer system 130 over communication lines 125. In one embodiment, the computing system 130 determines a duty cycle of a pulsed waveform 115, and, subsequently generates a torque value 132 from the determined duty cycle. The pulse displacement system 100 is responsive to a conditioned pulse waveform 115 received by the logic control circuit 120 from a comparator 110 for determining the duty cycle of the pulses. In embodiments, the conditioned pulse waveform 115 may be initially derived from a magnetic pick-up sensor (not shown) coupled to each of the displacement and reference-toothed wheels. The pick-up sensor (not shown) creates an analog electrical signal waveform 105 that provides time interval information representing the angular displacement measured by a displacement toothed wheel relative to a reference toothed wheel under rotor torque conditions. The displacement-toothed wheel includes one or more predetermined number of displacement teeth intermeshed (i.e., interfacing) with an equal number of reference teeth on a reference-toothed wheel. In an embodiment, as torque is applied to the rotor shaft due to a load on the engine, an angular displacement between the reference teeth relative to the displacement teeth will exist. This tooth displacement is sensed by a magnetic pick-up sensor creating an electrical pulse displacement waveform in which the pulse time relation represents the angular displacement. The magnetic pick-up sensor creates a pulse for each reference and displacement tooth that it senses and provides this as a pulse waveform 105 to the comparator 110. Also, the pulse displacement converter system 100 includes a computer system 130 having a software program stored in nonvolatile memory for executing instructions related to a torque value calculation algorithm utilizing the control logic output signals 125 generated from the pulse waveform 115 and transmitted from the logic control circuit 120. It is to be appreciated that the averaged pulse interval count values applied to computer system 130 are converted to a duty cycle and subsequently to a torque value that is utilized by engine control 135 for controlling the engine power setting even as the shaft speed is increasing or decreasing.

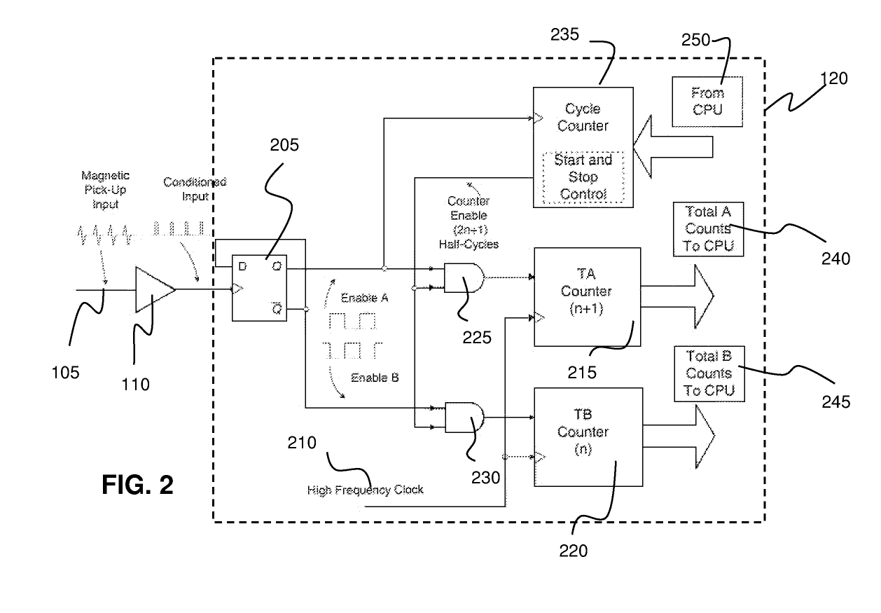

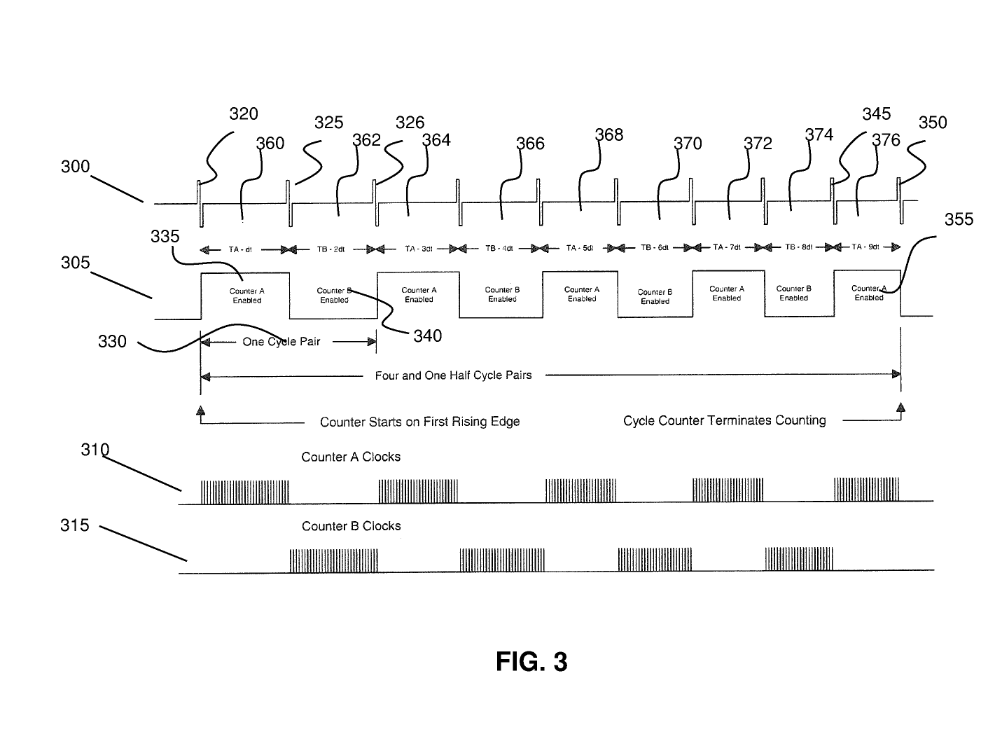

The logic control circuit 120 will now be explained in detail with reference to FIGS. 2 and 3 according to an embodiment of the invention. FIG. 2 illustrates a functional block diagram of the logic control circuit 120 for processing the electrical pulse outputs received from comparator 110, while FIG. 3 illustrates waveforms useful in explaining the operation of the logic control circuit 120.

In embodiments, the comparator circuit 110 receives an analog voltage waveform 105, which represents angular displacement of the sensor wheels on the rotor shaft. A magnetic pick-up sensor (not shown) senses the displacement and provides the waveform 105 to the comparator 110. Particularly, the pick-up sensor (not shown) senses the passing of the teeth on the toothed wheels and generates an electrical signal for each alternating tooth on the reference wheel and the displacement wheel. The alternating teeth on the wheels generates a series of pulses as waveform 105. The comparator 110 compares the waveform 105 to reference voltage to convert the waveform 105 into a standard logic pulse voltage waveform 300 (FIG. 3) that is compatible with the logic circuits 120 downstream of the comparator 110. In embodiments, the waveform 300 has a value of 5.0 Volts peak or 3.3 Volts peak. The waveform 300 depicts sensor signal pairs for alternating reference tooth and the displacement tooth signals, with pulses 320, 325 being the voltage pulses for the reference tooth and displacement tooth respectively. Of particular interest in the waveform of FIG. 3, in an example, is the result of increasing rotor speed (acceleration) on the pulse interval of waveform 300 and the change in apparent duty cycle of waveform 305 generated by the logic control circuit 120. As speed increases, the time between each successive pulse pair of waveform becomes shorter. This changes the duty cycle of waveform 305, which becomes greater than the ideal duty cycle. Waveform 300 illustrates pulse pairs alternating between the reference wheel and the displacement wheel. In the example shown in FIG. 3, during constant acceleration of the rotor shaft, the pulse intervals of waveform 300 will decrease at a constant rate such that each consecutive pulse duration will decrease at a fixed Delta t (dt). In one embodiment, the waveform 300 is provided to the trigger input of a D flip flop 205, which acts as a pulse dividing circuit for pulse waveform 300. Particularly, for every pulse pair 320, 325 (FIG. 3), the Q output changes state to produce one cycle of waveform 305 (FIG. 3), which is a duty cycle waveform with alternating high and low states. The duty cycle of waveform 305 is related to the time between pulse pairs 320, 325, and 326. In particular, waveform 305 (FIG. 3) shows one cycle 330 created by pulses 320, 325, and 326 (FIG. 3) with the first half cycle high state 335 being the period or duration of the displacement between the pulse pairs 320, 325 and the second half cycle low state 340 being the duration of the displacement between pulse pairs 325 and 326. In one example, cycle 330 has a high state generated from pulses 320, 325 and a low state generated from pulses 325, 326.

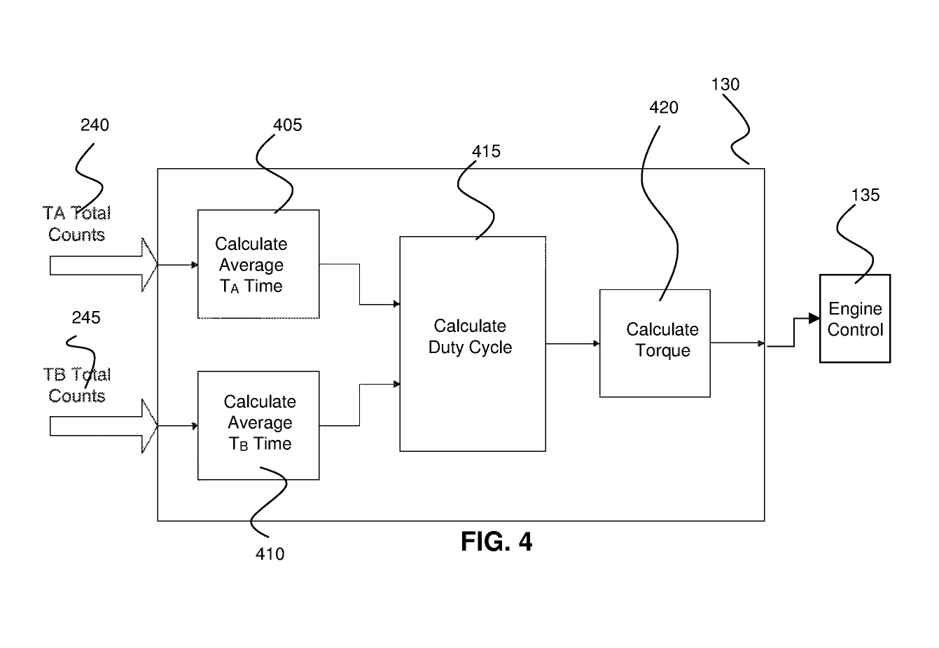

The waveform 305 is applied to a duty-cycle-to-digital-converter circuit (DCTDC) and a high frequency clock pulse signal 210 is applied to accumulate counts representing time for alternating high states and low states for waveform 305 (FIG. 3). Particularly, DCTDC circuit represented by the counter 215 and counter 220 with each receiving clock signal 210, and AND gates 225 and 230 which alternately enable counter 215 and counter 220. In an embodiment, the high frequency clock pulse signal 210 is about 12 MHz, although other clock pulse frequencies may be utilized without departing from the scope of the invention. After the AND gates 225 and 230 are enabled by the cycle counter 235 (i.e., start and stop control), the next rising edge (for example pulse 320) of the waveform 300 enables counter 215 (FIG. 2). Upon the next rising edge of waveform 300, such as pulse 325, counter 215 is disabled and counter 220 is enabled. In one embodiment, cycle counter 235 receives a command signal 250 from computer system 130 (FIG. 1), which enables the AND gates 225 and 230 to control the enable pin on counters 215 and 220 in order to turn-on the counters 215 and 220. This process is continued with counter 215 accumulating the time count values during the time interval that waveform 305 is in a high state and counter 220 accumulating the time counts during the interval that the waveform 305 is in a low state until the cycle counter 235 terminates the counting process at the falling edge of the last counter 215 enable pulse 355 with sensor signal pairs 345, 350 (FIG. 3). The process is controlled by the computer system 130 (FIG. 1), which transmits an enable signal 250 to control cycle counter 235 and loads the pulse interval count values, i.e., n+1 for counter 215 and n for counter 220 in order to set the number of intervals to be converted. After the predetermined number of consecutive adjacent intervals are processed, counter 215 and counter 220 counts are latched and total count value 240 for counter 215 and total count value 245 for counter 220 are sent to the computer system 130 (FIG. 1) for calculation of the duty cycle, as will be shown and described below with reference to FIG. 4. In one embodiment, the cycle counter 235 adds an additional half pulse interval 355 at the end of the pulse counting sequence on waveform 300 (FIG. 3) causing counter 215 to accumulate additional time counts during the time internal that waveform 305 is in a high state. This results in an odd number of counts (n+1) in counter 215 and an even number of counts (n) in counter 220. Waveform 310 illustrates the counter 215 clock pulses applied to counter 215 while waveform 315 illustrates the counter 220 clock pulses applied to counter 220 as each counter is enable on opposite states of waveform 305 (FIG. 3).

FIG. 4 illustrates a functional block diagram of a duty cycle algorithm used for calculating a duty cycle and torque value for an accelerating or decelerating rotor torque according to an embodiment of the invention. For ease of illustration and understanding, the functional block diagram of FIG. 4 illustrates an algorithm stored in memory on computer system 130 (FIG. 1) and executed by a microprocessor for providing a drive shaft torque value from the calculated duty cycle for a predetermined pulse cycle system. The microprocessor of computer system 130 can be any type of processor (CPU), including a general purpose processor, a digital signal processor, a microcontroller, an application specific integrated circuit, a field programmable gate array, or the like. In one embodiment, total time counts 240 and 245 for counters 215 and 220 (FIG. 2) are latched and sent to computer system 130 for computing a duty cycle of the input waveform voltage 105 (FIG. 1) for a predetermined number of cycle pairs.

For ease of understanding, reference is made to FIGS. 2, 3, and 4, the computer system 130 calculates the average pulse counts for counters 215 and 220 utilizing the sum of the counter 215 periods for n+1 cycle pairs and sum of the counter 220 periods for n cycle pairs. In this example, for ease of understanding, the ideal duty cycle is assumed to be 50% although the equations below may also be applied to an actual duty cycle that exhibits a range representing the drive shaft torque range. With n=4 in one embodiment, the average counts are calculated according to equations (2) and (4) below:

The total sum of the A clocks in n+1 pulse intervals (n=4) for counter 215 will be:

$$\begin{matrix}\begin{matrix}{T}_{A} total 240 = ( {T}_{A} - dt ) 360 + ( {T}_{A} - 3 dt ) 364 + ( {T}_{A} - 5 dt ) 368 + \\ ( {T}_{A} - 7 dt ) 372 + ( {T}_{A} - 9 dt ) 376 ; \\ = 5 {T}_{A} - 25 dt ;\end{matrix} & ( 1 ) \\ {T}_{A} Average 405 = ( 5 {T}_{A} - 25 dt ) \text{/} 4 = {T}_{A} - 5 dt ; & ( 2 )\end{matrix}$$

The sum of the B period times n pulse pairs (n=4) for counter 220 will be:

$$\begin{matrix}\begin{matrix}{T}_{B} total 245 = ( {T}_{B} - 2 dt ) 362 + ( {T}_{B} - 4 dt ) 366 + ( {T}_{B} - 6 dt ) 370 + \\ {(}_{TB} - 8 dt ) 374 ; \\ = 4 {T}_{B} - 20 dt ;\end{matrix} & ( 3 ) \\ {T}_{B} Average 410 = ( 4 {T}_{B} - 20 dt ) \text{/} 4 = {T}_{B} - 5 dt ; & ( 4 )\end{matrix}$$

### Where:

T_{A}=Total clock counts in counter 215 with n+1 count intervals;
T_{B}=Total clock counts in counter 220 with n count intervals;

$$\begin{matrix}\begin{matrix}{T}_{A} Average = Average of Torque counter 215 ; \\ = {T}_{A} \text{/} ( n + 1 ) ;\end{matrix} & ( 5 ) \\ \begin{matrix}{T}_{B} Average = Average of Torque counter 220 ; \\ = {T}_{B} \text{/} n\end{matrix} & ( 6 )\end{matrix}$$

Duty cycle 415 is calculated using equation (7) below:

$$\begin{matrix}{DC}_{A , B} = {T}_{A} \div ( {T}_{A} + {T}_{B} ) \\ = ( {T}_{A} - 5 dt ) \text{/} ( ( {T}_{A} - 5 dt ) + ( {T}_{B} - 5 dt ) ) ;\end{matrix} \qquad ( 7 )$$

In a 50% duty cycle waveform, T_{B}=T_{A}

Therefore:

$$\begin{matrix}= ( {T}_{A} - 5 dt ) \text{/} ( 2 \times ( {T}_{A} - 5 dt ) ) \\ = 1 \text{/} 2 ( i . e . , 50 \% duty cycle )\end{matrix}$$

### Where:

DC_{A,B}=Duty Cycle, in percent of waveform 300.

Further, the calculated duty cycle 415 is applied to a subroutine for calculating a torque value 420 by mapping the duty cycle 415 to actual applied torque by referencing the relationship of the teeth on the reference toothed wheel to an actual applied torque on the rotor shaft. The computer system 130 transmits the duty cycle 415 to an engine control 135 for application of the desired power command to the rotor shafts.

The technical effects and benefits of embodiments include an interval applied to the first of two interval counters for accumulating clock counts. It also includes an algorithm that calculates the average of the clock counts per pulse interval for both the interval counters.

The terminology used herein is for the purpose of describing particular embodiments only and is not intended to be limiting of the invention. While the description of the present invention has been presented for purposes of illustration and description, it is not intended to be exhaustive or limited to the invention in the form disclosed. Many modifications, variations, alterations, substitutions, or equivalent arrangement not hereto described will be apparent to those of ordinary skill in the art without departing from the scope and spirit of the invention. Additionally, while various embodiment of the invention have been described, it is to be understood that aspects of the invention may include only some of the described embodiments. Accordingly, the invention is not to be seen as limited by the foregoing description, but is only limited by the scope of the appended claims.

1. A pulse displacement system, comprising:
a sensor for generating an analog waveform indicative of an angular displacement of a reference wheel from a displacement wheel;
a comparator for generating a pulse waveform of the analog waveform;
a flip flop for generating a duty cycle waveform responsive to the generating of the pulse waveform;
a first counter for accumulating a first count of high states of the duty cycle waveform;
a second counter for accumulating a second count of low states of the duty cycle waveform; and
a processor for determining a first average for the first count and determining a second average for the second count;
wherein the first count includes an additional high state over the low state; and
wherein the processor calculates a duty cycle of the pulse waveform as a function of the first average and the second average.

2. The system of claim 1, further comprising an AND gate for transmitting an enabling signal to the first counter and the second counter.

3. The system of claim 1, wherein the processor maps the calculated duty cycle to an actual torque value.

4. The system of claim 1, wherein the pulse waveform represents alternating displacements of a reference tooth on the reference wheel with a displacement tooth on the displacement wheel.

5. The system of claim 1, wherein the high state represents a first duration between a first pulse adjacent to a second pulse in the pulse waveform.

6. The system of claim 5, wherein the low state represents a second duration between the second pulse adjacent to a third pulse in the pulse waveform.

7. The system of claim 1, wherein the duty cycle waveform includes the high state alternating with the low state.

8. The system of claim 1, wherein the first counter is enabled on a positive edge of the duty cycle waveform.

9. The system of claim 1, wherein the second counter is enabled on a negative edge of the duty cycle waveform.

10. A method for determining a duty cycle in a pulse displacement system, comprising:
generating, via a sensor, an analog waveform indicative of an angular displacement of a reference wheel from a wheel;
generating, via a comparator, a pulse waveform of the analog waveform;
generating, via a flip flop, a duty cycle waveform responsive to the generating of the pulse waveform;
accumulating, via a first counter, a first count of high states of the duty cycle waveform;
accumulating, via a second counter, a second count of low states of the duty cycle waveform;
determining, via a processor, a first average for the first count and a second average for the second count; and
calculating, via the processor, the duty cycle of the pulse waveform as a function of the first average and the second average;
wherein the first count includes an additional high state of the duty cycle waveform.

11. The method of claim 10, further comprising transmitting, via AND gates, an enabling signal to the first counter and the second counter.

12. The method of claim 10, further comprising mapping the calculated duty cycle to an actual torque value.

13. The method of claim 10, wherein the pulse waveform represents alternating displacements of a reference tooth on the reference wheel with a displacement tooth on the displacement wheel.

14. The method of claim 10, wherein the high state represents a first duration between a first pulse adjacent to a second pulse in the pulse waveform.

15. The method of claim 14, wherein the low state represents a second duration between the second pulse adjacent to a third pulse in the pulse waveform.

16. The method of claim 10, wherein the duty cycle waveform includes the high state alternating with the low state.

17. The method of claim 10, further comprising enabling the first counter on a positive edge of the duty cycle waveform.

18. The method of claim 10, further comprising enabling the second counter on a negative edge of the duty cycle waveform.
